(19) United States
(12) Patent Application Publication
(10) Pub. No.: US 2026/0066252 A1
(43) Pub. Date: Mar. 5, 2026

(54) Aerosolisation System and Methods of Use Thereof

(71) Applicant: Vibrat-Ion Ltd, Ceredigion (GB)

(72) Inventors: David KILGOUR, Nottingham (GB); Mark NEAL, Ceredigion (GB)

(21) Appl. No.: 19/104,490

(22) PCT Filed: Apr. 25, 2023
(86) PCT No.: PCT/GB2023/051093

§ 371 Date: Feb. 18, 2025

(30) Foreign Application Priority Data
Aug. 19, 2022 (GB) 2212137.0

(51) Int. Cl. H01J 49/04; H01J 49/00

(52) U.S. Cl. CPC H01J 49/0445; H01J 49/0031; H01J 49/0454

(57) ABSTRACT

An aerosolisation system (10) is provided for producing at least one aerosol plume (78) of, optionally charged, droplets (80). The aerosolisation system (10) has a nebuliser (14a), electrically-energisable vibration means (36), and AC control circuit (46b) and an offset voltage controller (68). The nebuliser (14a) includes a vibratable sheet (34) having a first surface (38a) for receiving liquid (76) thereupon, a second surface (38b) opposite the first surface (38a), and an aperture (38c) for permitting fluid therethrough, the aperture (38c) extending from the first surface (38a) to the second surface (38b). The electrically-energisable vibration means (36) in-use causes the vibratable sheet (34) to vibrate. The AC control circuit (46b) has a programmable controller and is configured to control a power supply (30) to output an alternating current to the nebuliser (14a). The offset voltage controller (68) is configured to control a power supply (30) to output an offset voltage to the alternating current control circuit (46b) so that in-use the said alternating current outputted to the nebuliser (14a) is offset by an offset voltage for controlling the production of charged droplets (80) from a liquid (76) received on the first surface (38a).

The present invention relates to an aerosolisation system for producing an aerosol containing a plume of charged droplets. The present invention also relates to a method of use of the aerosolisation system.

Mass spectrometry is an example of a laboratory technique used to identify and/or quantify the chemical makeup of a sample. One of the most common classes of mass spectrometer typically receives an aerosol containing charged droplets of a solution for analysis; the solution contains analytes of interest. The mass spectrometer is designed to aid in the evaporation of the solvent from these charged droplets to permit the production of gas phase ions of the analytes of interest. This process is usually summarized under the general heading “electrospray ionisation”. There are other methods for producing ions from uncharged aerosol plumes, such as atmospheric pressure chemical ionisation and atmospheric pressure photoionisation. However the gas phase ions are produced, the mass spectrometer separates the ions based on their mass to charge ratios and sums the ions received over a duration of time, referred to as the “ion accumulation period”. The output of a mass spectrometer is a mass spectrum, which is a graph showing the relative abundances of the various ions against their mass to charge ratio (m/z). The identities of the ions detected is inferred, in large part, from the m/z recorded for that ion. Therefore, any miscalibrated apparatus may provide erroneous data, and thus misidentification of the sample.

The term “aerosolisation” refers to the process of transformation a liquid sample into an aerosol formed of a plurality of droplets. The droplets may be one of: neutral, charged positively, and charged negatively. A random sample of an aerosol taken at a given time may contain any combination of: a first subset of neutral droplets, a second subset of positive droplets, and a third subset of negative droplets. Where an aerosol includes only neutral droplets, the aerosol is overall or net neutral. When the aerosol contains a subset of positive droplets and a subset of negative droplets, and optionally neutral droplets, the aerosol is neutral overall or net neutral when the positive droplets are in equal or substantially equal proportion to the negative droplets. In contrast, where the proportions of positive and negative droplets differ from each other, the aerosol is “net charged”, and more specifically, “net positive” when the proportion of positive droplets is greater than the proportion of negative droplets or “net negative” when the proportion of negative droplets is greater than the proportion of positive droplets. A net positive or net negative plume may or may not include a subset neutral droplets in addition to the charged droplets. If the aerosol is elongate in shape, the aerosol may be referred to as a plume or aerosol plume.

Some devices, such as the above-mentioned mass spectrometer, require a net charged aerosol of droplets to be able to generate gas-phase ions therefrom. A current issue is to provide an aerosol of droplets which is reliably net charged. An existing solution is to provide a capillary which contains liquid. The capillary is held at a high potential and the electric field between the capillary tip and the nearby conductive surface (often the front of the mass spectrometer) transforms the liquid into a charged aerosol. Whilst providing a viable, reliably net charged aerosol plume, capillaries have drawbacks. Capillaries are expensive, and slow to activate and disactivate. Capillaries need to also be cleaned between uses, which is a slow process. A capillary requires a large volume of liquid to function. Additionally, as much residual liquid remains in the capillary after use, liquid is wasted. The risk of contamination of the following sample is also high. To analyse a reaction, the reagents need to be mixed prior to addition into the capillary, which is inefficient in both time and sample volume.

The present invention seeks to provide a solution to these problems.

According to a first aspect of the present invention, there is provided an aerosolisation system for producing at least one aerosol plume of charged droplets, the aerosolisation system comprising: a nebuliser including a vibratable sheet having a first surface for receiving liquid thereupon, a second surface opposite the first surface, and an aperture for permitting fluid therethrough, the aperture extending from the first surface to the second surface; an electrically-energisable vibration means for causing the vibratable sheet to vibrate; an AC control circuit having a programmable controller, the AC control circuit being configured to control a power supply to output an alternating current to the nebuliser; and an offset voltage controller being configured to control a power supply to output an offset voltage to the alternating current control circuit so that in-use the said alternating current outputted to the nebuliser is offset by an offset voltage for controlling the production of charged droplets from a liquid received on the first surface.

The term “AC” used herein and throughout is intended to mean alternating current. Similarly, the term “DC” used herein and throughout is intended to mean direct current. The offset voltage controller is set up to deliver an offset voltage to the AC when required. Depending on the value and charge of the offset voltage when the offset voltage is applied, the resulting aerosol is reliably one of: net neutral, net positive, and net negative. Thus, the offset voltage controller provides a means of controlling the net polarity of the aerosol. Furthermore, a nebuliser provides fine control over the volume and timing of aerosolisation. For instance, the nebuliser can aerosolise small volumes of highly concentrated solutions as well as volumes of dilute solutions which are larger by several orders of magnitude. A nebuliser is able to modulate the volume and/or rate of aerosolisation between spectra, and even within the ion accumulation phase of a spectrum if required.

Optionally, the aerosolisation system may further comprise a capillary for producing a further aerosol plume of droplets. A second plume of droplets may thereby be produced. The droplets may be charged or non-charged.

Preferably, the vibration means may include a piezo element. When energised, a piezo element vibrates at an ultrasonic frequency. As such, the vibratable sheet may be made to vibrate at an ultrasonic frequency. The term “ultrasonic” used herein and throughout is considered to mean at least 20 kilohertz.

Beneficially, the sheet may be a metal sheet. Metal is a robust and conductive material which enables an electrical current to pass through the metal sheet. However, any alternative, preferably conductive, material may be used, such as graphene, or ceramic. Optionally, the offset voltage controller may be a DC offset voltage controller which may be configured to control a power supply to output a DC offset voltage. The AC may be in-use offset by fixed, set or unvarying voltage.

Beneficially, the DC offset voltage controller may be configured to control the power supply to output a DC offset voltage having an absolute value of at least 20 Volts. The offset voltage is preferably a non-null voltage, although this alternative may be an option, if a net neutral aerosol is desired. Furthermore, the offset voltage may have a positive or negative value to produce a net positive or net negative aerosol plume respectively. More preferably, the DC offset voltage controller may be configured to control the power supply to output a DC offset voltage having an absolute value of at least 1000 Volts. A high voltage value, whether negative or positive, may reduce or even eliminate the subset of neutral droplets from the plume such that the plume only contains or contains a higher proportion of charged droplets.

Alternatively, the offset voltage controller may be an AC offset voltage controller which may be configured to control a power supply to output an AC offset voltage to the said alternating current control circuit. The value of the offset voltage applied to the AC is variable or varying over time, instead of being a fixed value over time.

Preferably, the aerosolisation system may further comprise an actuator for moving the nebuliser and/or the capillary. One or both of the nebuliser and the capillary may be movable. In an aerosolisation system fitted with both a capillary and a nebuliser, either one of the capillary and the nebuliser may be moved into a desired position relative to each other and/or relative to a third device to orient the aerosol plume or plumes as required. If only one of the capillary and the nebuliser is required, the other may be moved out of the way. If a plurality of capillaries and/or nebulisers are provided, mobility enables a plurality of capillaries and/or a plurality of nebulisers to be used. The movement may be manual and/or automated, for example by means of one or more actuators. Movement due to an actuator may be more precise than manual movement. Additionally, an actuator can be programmable and/or operable remotely, such as from a computing device. Remote control of the actuator may be particularly beneficial if physical access to the nebuliser and/or capillary is restricted.

According to a second aspect of the present invention, there is provided a method of using an aerosolisation assembly for producing at least one aerosol plume of droplets, the method comprising the steps of: a] providing an aerosolisation system, preferably in accordance with the first aspect; b] adding a volume of liquid onto the first surface of the vibratable sheet and producing an aerosol plume of droplets by activating the AC control circuit to control a power supply to provide an alternating current to the nebuliser and optionally activating the offset voltage controller to control a power supply to provide an offset voltage to the AC control circuit to cause the vibratable sheet to vibrate for producing an aerosol plume of charged droplets from the volume of liquid. The method enables the production of an aerosol plume which is reliably either net neutral, net positive or net negative.

Beneficially, step a] may further comprise providing an aerosolisation apparatus for producing a second aerosol plume of droplets. Additionally, the method may further comprise a step c] after step a] of adding a volume of a second liquid to the aerosolisation apparatus so as to produce the second aerosol plume of droplets. Preferably, the aerosolisation apparatus may be a capillary. Even more preferably, the aerosolisation apparatus may be an electrospray capillary or needle. A second aerosol plume may be produced by the addition of an aerosolisation apparatus. The second plume may be net neutral, net positive or net negative. Step c] may occur at any time after step a], including before, concomitantly with, or after step b] or any other subsequent step after step a]. Advantageously, step a] may further comprise providing a device that uses and/or analyses gas phase ions, preferably having an inlet aperture. Although the aerosolisation system and/or any aerosolisation apparatus may be provided as part of or within the device that uses and/or analyses gas phase ions, preferably, the device has an inlet aperture for receiving droplets of one or more aerosols therethrough.

Preferably, the method may further comprise a step d] after step a] of orientating the second surface of the vibratable sheet to face the aerosolisation apparatus so as to direct the first said aerosol plume of droplets to or towards the aerosolisation apparatus. Again, step d] may occur at any time after step a], including before, concomitantly with, or after step b], step c], or any other subsequent step after step a]. The aerosol plume produced by the nebuliser extends or is directed to or towards aerosolisation apparatus. This may enable the first and second said aerosol plumes to mix. More preferably, the second surface of the vibratable sheet may face an outlet of the aerosolisation apparatus so as to direct the first said aerosol plume of charged droplets to or towards the outlet of the aerosolisation apparatus. Droplets from the first said aerosol plume may mix with droplets from the second aerosol plume on or around the outlet of the aerosolisation apparatus, which may be more efficient as the second aerosol plume is denser at or adjacent the outlet, relative to downstream of the outlet. If both plumes have the same net polarity, droplets of same polarity repel each other.

Alternatively or additionally, the method further comprising a step e] after step a] of orientating the second surface of the vibratable sheet to face the inlet aperture of the device that uses and/or analyses gas phase ions so as to direct the first said aerosol plume of droplets to, toward or adjacent to the inlet aperture. Again, step e] may occur at any time after step a], including before, concomitantly with, or after step b], step c], step d], or any other subsequent step after step a]. Step e] may optionally occur before, after or instead of step d]. If step e] and step d] are concurrent, the aerosolisation system may require a plurality of nebulisers activated simultaneously or sequentially.

Optionally, at least one of the first said liquid and the second liquid may include a calibration solution or calibrant ion for calibration or recalibration during use or analysis of gas phase ions by the device that uses and/or analyses gas phase ions. A calibration solution or calibrant ion provides known or expected results which enable the device to be calibrated or the calibration to be checked. Any miscalibration is or is more likely to be identified and rectified, to ensure an accurate output. Due to having multiple sources of aerosol plumes, calibration can be carried out before, simultaneously with or after analysis of a sample, without requiring a user to alter any settings or manipulate the device between calibration and analysis. Calibration may be simpler, faster, and carried out more regularly.

Alternatively, the first liquid may include a first reagent and the second liquid may include a second reagent, and the first reagent may react with the second reagent when the first and second reagents are mixed for enabling analysis in real-time of a chemical or biochemical reaction by the device that uses and/or analyses gas phase ions. A nebuliser provides greater control over the volume and the timing of the aerosolisation of a liquid, at least compared to existing apparatuses. Thus, a chemical or biochemical reaction can be carried out by mixing aerosol plumes of reagents, with the user having finer control over the start and end of the chemical reaction as well as a finer control of the volumes of reagents. Furthermore, a nebuliser allows a user access to deposit liquid on the first surface thereof, as required, including during operation of the aerosolisation system. Real time or substantially real time analysis of the reaction is enabled. In contrast, some prior art devices require mixing of the reagents prior to aerosolisation such that it may not be possible to analyse the start of a reaction and/or to obtain real-time data.

Preferably, the device that uses and/or analyses gas phase ions may be a mass spectrometer.

Beneficially, at least one of the first liquid or part thereof and the second liquid or part thereof has a known mass spectrum; step b] may be carried out during a first period of time and step c] may be carried out during a second period of time, wherein the first and second periods of time may be partially overlapping for enabling comparison of the spectrum emitted by the mass spectrometer of ions from both first and second liquids with the spectrum emitted by the mass spectrometer of ions of only one of: the first liquid and the second liquid for enabling identification or confirmation of the identity of any ion or ions common to both liquids. The user can identify or confirm the identity of one or more ions by comparing two spectra. If a same ion is produced from both liquids, the relative abundance of the corresponding peak will differ between the spectra, leading to positive identification or confirmation of the identity of the ion.

Alternatively, at least one of: the first liquid and or part thereof, and the second liquid or part thereof has a known mass spectrum, wherein at least one of: the AC control circuit and the offset voltage controller may alter the volume and/or a rate of aerosolisation of the first liquid by altering the output to the electrically-energisable vibration means for enabling comparison a first spectrum emitted by the mass spectrometer of ions of both first and second liquids whereby the liquid or part thereof having a known mass spectrum has been aerosolised at a first rate of aerosolisation, the first spectrum being compared against a second spectrum of ions of both liquids whereby the liquid or part thereof having a known mass spectrum has been aerosolised at a second rate of aerosolisation different to the first rate of aerosolisation for enabling identification or confirmation of at least part of the composition of the liquid which is being analysed. The liquid being analysed may optionally be aerosolised at a constant or substantially constant rate. Once again, the user can identify or confirm the identity of one or more ions by comparing two spectra. However, as ions of the liquid having a known composition are present in both instances albeit in different proportions, both spectra contain the same mass to charge ratio peaks but the relative abundance of all or a subset of the ions varies between spectra, illustrated by a height variation or all or a subset of peaks in the spectra. The variable peak or peaks enable identification or confirmation of the identity of the ion or ions.

The term “rate of aerosolisation” used herein and throughout is intended to mean the volume of liquid being transformed into an aerosol form over a given period of time. Optionally, the method may further comprise a step f] after step a] of adding a volume of third liquid to the nebuliser of the aerosolisation system so that the first liquid mixes with the third liquid. Mixing of, preferably distinct, liquids may be carried out directly on the same nebuliser, instead of or in addition to mixing at the outlet of the capillary. Although referred to as “third said volume of third liquid”, it is understood that there may be only two liquids: the first liquid and the third liquid. Additionally, no order is implied by the use of “first”, “second” and “third”. Instead, the different liquids may be added in any order relative to each other. Two or more liquids may be added simultaneously to each other. According to a third aspect of the present invention, there is provided an aerosolisation system for producing an ionised aerosol for a device that uses and/or analyses gas phase ions, the aerosolisation system comprising: a nebuliser including a vibratable sheet having a first surface for receiving liquid thereupon, a second surface opposite the first surface, and at most 100 apertures for permitting fluid therethrough, the apertures extending from the first surface to the second surface; and an energisable vibration means for inducing the vibratable sheet to vibrate. Preferably, the vibratable sheet may have at most 19 apertures. More preferably, the vibratable sheet may have at most 7 apertures. Most preferably, the vibratable sheet may have exactly one aperture. A small number or even a single aperture in the nebuliser provides greater control over the volume and/or rate of aerosolisation. If a small volume of residual liquid remains in the apertures, a smaller number of apertures may reduce the total volume of residual liquid. One aperture provides the greatest control. A plurality of apertures provides redundancy, for instance, if one aperture becomes obstructed. Additionally, a plurality of apertures distributed throughout the sheet reduce the risk of liquid remaining on the first surface, spaced-apart from an aperture, as this would alter the volume of liquid that is aerosolised. The nebuliser may be provided in isolation, as a consumable.

The invention will now be more particularly described, by way of example only, with reference to the accompanying drawings, in which:

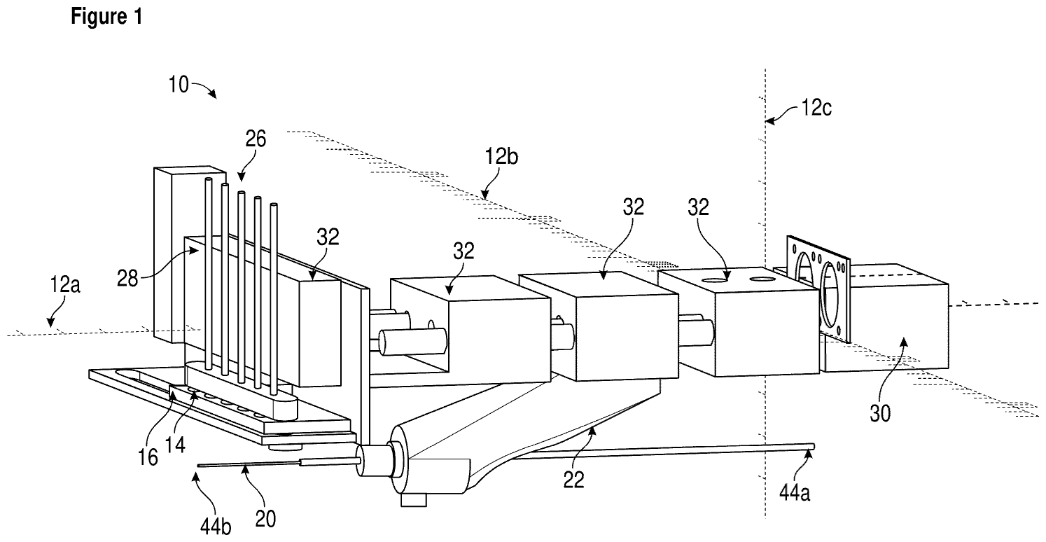

FIG. 1 shows a perspective representation of an embodiment of an aerosolisation system in accordance with the first aspect of the invention, the aerosolisation system including five first aerosolisation apparatuses in the form of five nebulisers, and a second aerosolisation apparatus in the form of a capillary;

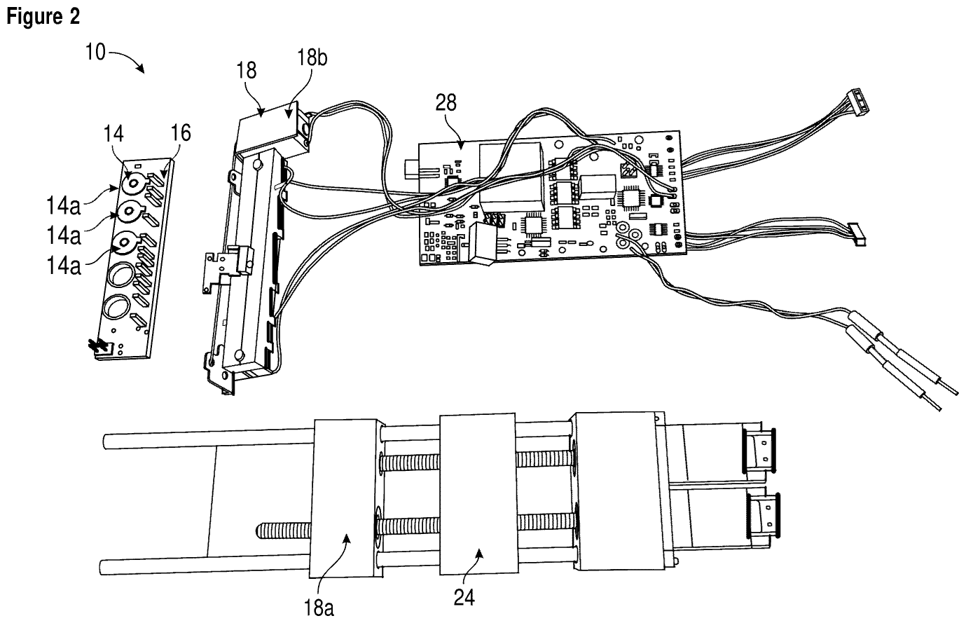

FIG. 2 is an exploded view of the aerosolisation system of FIG. 1, with the second aerosolisation apparatus, a second aerosolisation-apparatus support body, a system power source, liquid-deposition means, a plurality of housings, and part of the first aerosolisation-apparatus support body omitted for clarity;

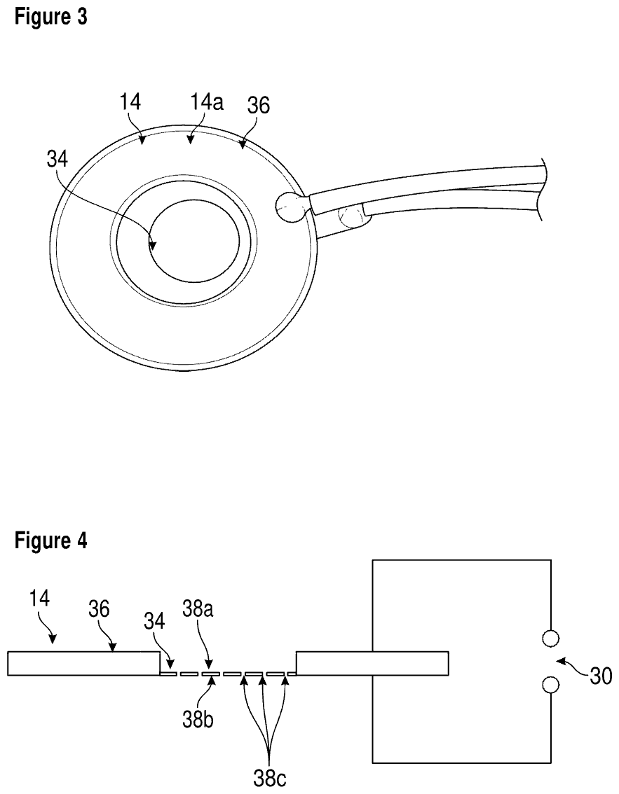

FIG. 3 illustrates a perspective top view of an embodiment of a nebuliser of the aerosolisation system of FIG. 1;

FIG. 4 shows a cross-sectional representation of the nebuliser of FIG. 3 connected to a power source;

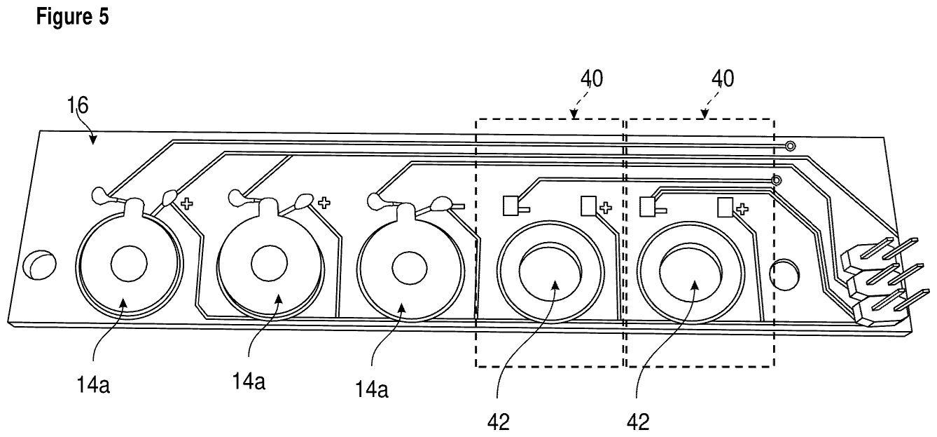

FIG. 5 illustrates a perspective top image of three of the five nebulisers mounted on part of the first aerosolisation-apparatus support body of the aerosolisation system of FIG. 1;

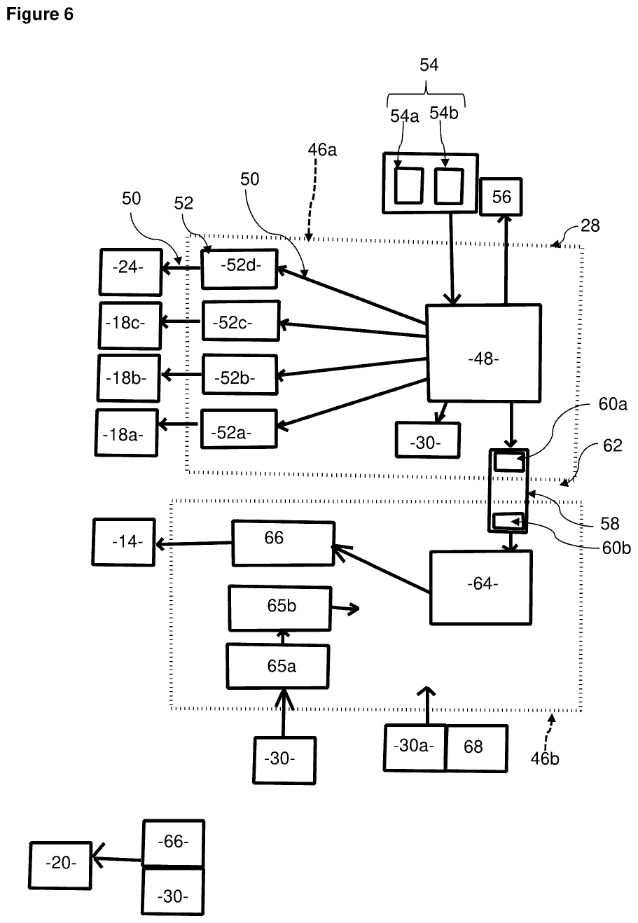

FIG. 6 shows a diagrammatic representation of control means of the aerosolisation system of FIG. 1;

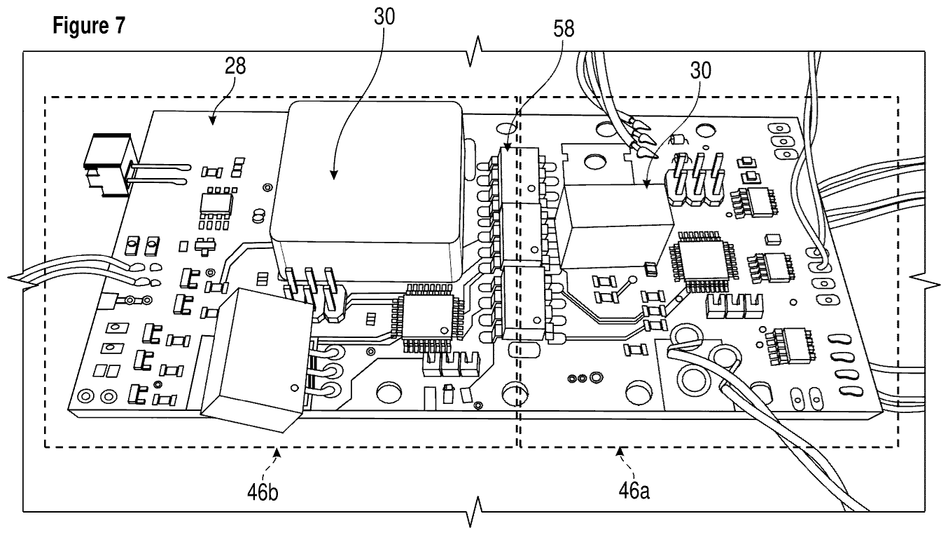

FIG. 7 shows a perspective top view of part of the control means;

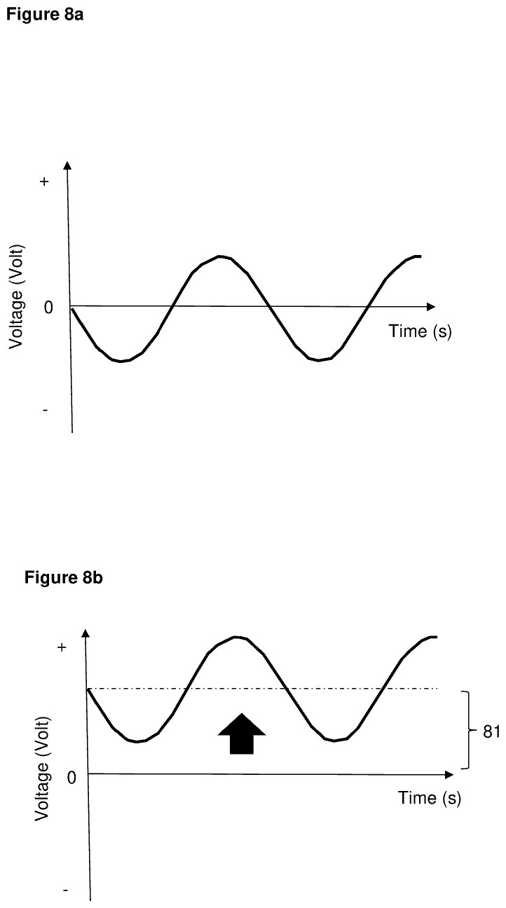

FIG. 8a is a graph of the AC supplied to a said nebuliser before an offset voltage is applied to the AC;

FIG. 8b shows a graph of the AC supplied to a said nebuliser whilst the offset voltage is applied to the AC;

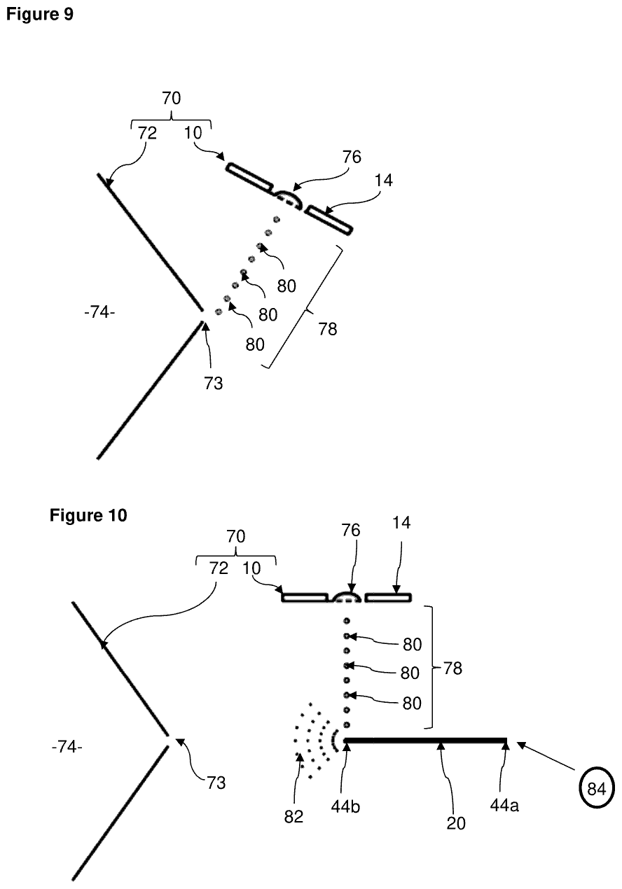

FIG. 9 illustrates part of the aerosolisation system of FIG. 1 and an inlet aperture of a device that uses and/or analyses gas phase ions, in-use in accordance with the second aspect of the invention, in which the aerosol plume from the nebuliser is directed to, toward or adjacent to the inlet aperture;

FIG. 10 shows part of the aerosolisation system of FIG. 1 and an inlet aperture of a device that uses and/or analyses gas phase ions, in-use in accordance with the second aspect of the invention, in which the aerosol plume from the nebuliser is directed to, toward or adjacent to an outlet of the capillary;

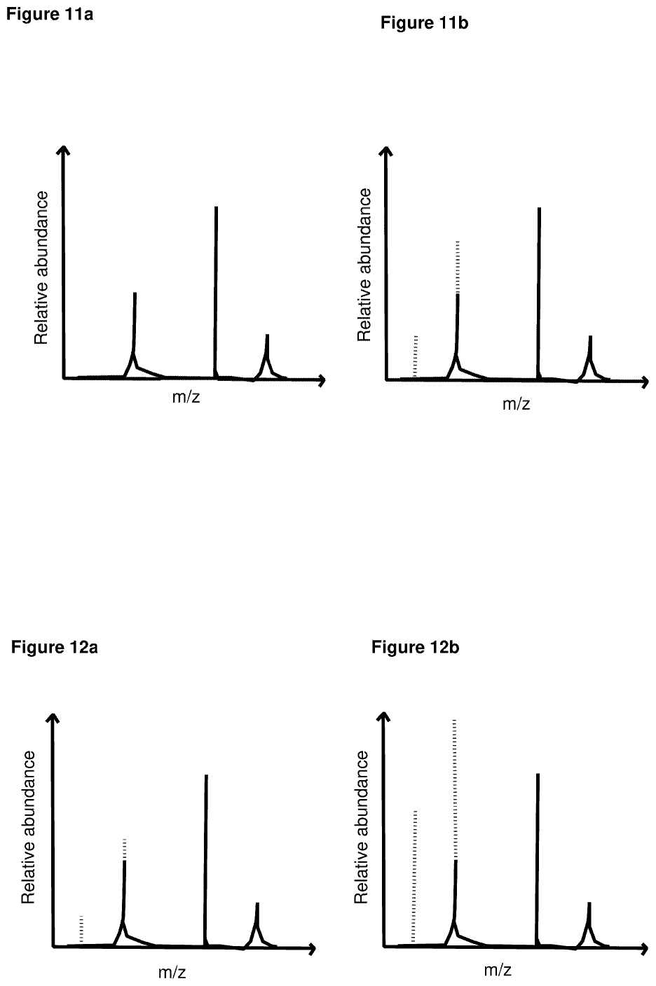

FIG. 11a illustrates an example of a mass spectrum emitted by a mass spectrometer of ions of a liquid being analysed following aerosolisation of the liquid in accordance with the second aspect of the invention;

FIG. 11b shows a mass spectrum of ions of two liquids, one of liquids being the liquid resulting in the mass spectrum of FIG. 11a, and the second liquid or part thereof having a known output, the liquids being aerosolised in accordance with the second aspect of the invention;

FIG. 12a illustrates an example of a mass spectrum following aerosolisation of two liquids in accordance with the second aspect of the invention, one of the liquids or part thereof having a known output and being aerosolised at a first rate of aerosolisation; and FIG. 12b is a mass spectrum following aerosolisation of the same two liquids of FIG. 12a in accordance with the second aspect of the invention, the liquid or part thereof having a known output being aerosolised at a second rate of aerosolisation, distinct from the first rate of aerosolisation.

Referring to FIG. 1, there is shown a system generally indicated at 10 for producing at least one aerosol plume of droplets. The system may thus be referred to as an aerosolising or aerosolisation system 10. The droplets of liquid include one or more molecules which may or may not be charged. The droplets are suspended in gas. The aerosolisation system 10 may also impart momentum to the droplets. The aerosolisation system 10 may optionally define or extend along a primary axis 12a. Any movement therealong may be referred to as axial movement. For simplicity, the primary axis 12a may be considered to be the X-axis. As shown in FIG. 1, two further axes are shown, referred to as the Y-axis 12b and the Z-axis 12c for clarity. The width of the system 10 or any part thereof is measured in the Y-axis, whilst the height of the system 10 or any part thereof is measured in the Z-axis.

The aerosolisation system 10 includes a first aerosolisation apparatus 14, a first aerosolisation-apparatus support body 16, a first actuator 18, a second aerosolisation apparatus 20, a second aerosolisation-apparatus support body 22, a second actuator 24, liquid-deposition means 26, control means 28, and a power supply 30, although any of the above may be omitted and/or a plurality of any of the above may be provided. Additional features may be provided, as required. Any or all the above features may be provided within one or more housings 32. FIG. 2 shows an exploded view of internal components of the system 10.

The terms “first” and “second” are used to distinguish similar features for clarity, and are not intended to imply an order. If either of the “first” or “second” aerosolisation apparatus is omitted, the other of the “first” or “second” aerosolisation apparatus may simply be referred to as an aerosolisation apparatus. Similar reasoning may be applied to any features referred to as “first” and “second” for clarity. Further incremental naming may be used for further corresponding features, as required.

The first aerosolisation apparatus 14 in-use transforms a liquid into an aerosol. Whilst any aerosol-producing apparatus may be envisioned, the first aerosolisation apparatus 14 in the preferred embodiment includes a nebuliser 14a as shown in FIG. 3. The nebuliser 14a is schematically represented in FIG. 4, connected to a power supply or power source 30. When the first aerosolisation apparatus 14 is a nebuliser, the process of aerosolisation may be referred to as “nebulisation”.

More preferably yet, the nebuliser 14a is an ultrasonic nebuliser 14a, but a non-ultrasonic nebuliser may be an option. The nebuliser 14a includes a vibratable sheet 34 and vibration means 36. The nebuliser 14a has a constant spray rate of 100 microlitres per minute (μL/min) at most, and more preferably of 50 μL/min at most. Most preferably, the nebuliser 14a has a constant spray rate of 20 μL/min at most. The nebuliser 14a is adapted or configured to aerosolise a volume of at most 1 millilitre (mL), although greater than a millilitre is an option. More preferably, in-use, the nebuliser 14a can aerosolise a volume of less than 1 nanolitre (nL), and more preferably less than 100 picolitres. More preferably, the nebuliser 14a is able to generate droplets of 50 picolitres or less, and more preferably, 20 picolitres or less.

The vibratable sheet, plate, or diaphragm 34 is illustrated as being circular but the exact shape is not critical such that the vibratable sheet may have any other suitable shape, such as square or rectangular. The vibratable sheet 34 is preferably formed of metal or a metal alloy, such as nickel-cobalt, but non-metal may be an option. The sheet 34 may optionally be 50 micrometres thick but any other suitable thickness may be an option. The vibratable sheet 34 has a first surface 38a for receiving liquid thereupon, a second surface 38b opposite the first surface 38a, and at least one aperture 38c for permitting fluid therethrough. The sheet 34 is preferably planar or substantially planar. Thus, the sheet 34 may be considered to extend along a defining plane. An axis normal to the defining plane may be referred to as a through-put axis or nebuliser output axis. In-use, the nebuliser 14a emits an aerosolise plume of droplets which may move at least in part along the nebuliser output axis.

The or each aperture 38c, also referred to as a channel or through bore, extends from the first surface 38a to the second surface 38b, as best shown in FIG. 4. Preferably, the sheet 34 has at most 100 apertures 38c, although a greater number of apertures, such as 120, 130, 140, 150, 160, 170, 180, 190, 200, 300, 400, 500, 1000 or more. More preferably, the sheet 34 may have, in increasing order of preference, 90, 80, 70, 60, 50, 40, 30, 20, 19, 18, 17, 16, 15, 14, 13, 12, 11, 10, 9, 8, 7, 6, 5, 4, 3, or 2 apertures, or any number therebetween. More preferably yet, the sheet 34 may have at most 19 apertures 38c, and even more preferably at most 7 apertures 38c. The apertures 38c may have any distribution across the sheet 34, but a regular distribution, such as apertures forming a shapes such as hexagons, rectangles or squares, by way of example, is preferred. Optionally an aperture may be provided at or adjacent a centre of the shape. A nebuliser 14a having an array of, preferably regularly-distributed apertures 38c may often be referred to in the technical field as a “mesh nebuliser” or a “pierced foil nebuliser”. In a preferred embodiment, the sheet 34 may have exactly one aperture 38c. The aperture 38c may be centrally positioned. The or each aperture 38c is preferably formed by a laser during manufacture. Each aperture 38c is preferably circular in cross-section but non-circular may be an option. Preferably, the, each or at least one aperture 38c has a diameter or cross-sectional dimension of at most 100 micrometres (μm), although greater than 100 μm may be an option. More preferably, the diameter or cross-sectional dimension is less than 20 μm and more preferably is 10 μm. The diameter or dimension may even be 3 μm. The diameter or dimension may be determined by the diffraction limit of the laser. Smaller values may be achieved, for example if using other methods of manufacture.

The vibration means 36 in-use induces or causes the vibratable sheet 34 to vibrate. The vibration means 36 may be referred to as a vibration element, vibrating element or part, a vibrator, a sheet-actuator, or a wave-emitting element. The vibration means 36 is energisable, and more preferably electrically-energisable. The vibration means 36 preferably includes a non-conductive material. Furthermore, the vibration means 36 is preferably chemically inert. This preferably prevents or reduces the risk of the vibration means 36 reacting with a liquid on the vibratable sheet 34. The vibration means 36 includes a piezo element or piezo crystal in the preferred embodiment, but nebulisers having non-piezo electric vibration means may be an option. The vibration means may have an actuator by way of example only. Any material which can produce a piezo effect may be considered, although in the preferred embodiment, the piezo element preferably includes a piezo electric ceramic material, such as lithium ionate or zirconium titanate by way of examples. Preferably, the vibration means 36 does not include metal. The vibration means 36 is positioned on, in, or abutted against the second surface 38b and/or, preferably, the first surface 38a of the sheet 34. The vibration means 36 is preferably a hollow disc, ring or torus in the shown embodiment, but any alternative shape may be envisioned. A ring has a benefit of preventing or inhibiting any volume of liquid received on the surface which the vibration means 36 is associated with from accidentally flowing off an edge of the relevant surface. Any alternative shape may be envisioned however, such as a bar, a square, or a circle by way of example. In most in-use cases however, the vibration means 36 is spaced-apart from any liquid received on the first surface 38a, even if the vibration means 36 is associated with the first surface 38a. In other words, the liquid preferably does not contact the vibration means 36 in-use.

The first aerosolisation apparatus 14 and/or the second aerosolisation apparatus 20, or any part of either or parts of both may be enclosed within a housing, not shown, but this is optional as any of the above may be open. If one or more apparatuses are used with a device that uses and/or analyses gas phase ions, referred to as an analysis device, the housing may optionally extend from the analysis device, and optionally at or adjacent to an inlet thereof, to one or both apparatuses. The housing may extend to at or adjacent to the outlet of either or both apparatuses. The housing may even enclose or surround any of: the first aerosolization apparatus 14, the second aerosolization apparatus 20, the analysis device, and a space between any combination of the above. The housing may prevent or inhibit a draught of air affecting the aerosol plume produced by either or both apparatuses. This may beneficially provide access to the first aerosolisation apparatus 14 and more preferably to the vibratable sheet 34 if a nebuliser when in use. A user may for example, pipette a liquid directly onto the sheet if required.

The first aerosolisation-apparatus support body 16, also referred to as a first mount, or nebuliser mount, provides a support or mount for the first aerosolisation apparatus 14. The first aerosolisation-apparatus support body 16 preferably includes at least a board and more preferably a printed circuit board or PCB, but any alternative mount may be envisioned, such as a clamp or isolated base. Optionally, the first aerosolisation-apparatus support body 16 may support or enable mounting of the liquid-deposition means 26. The first aerosolisation-apparatus support body 16 includes at least one, and preferably a plurality of apparatus-mounting areas 40. Two such apparatus-mounting areas 40 are outlined in FIG. 5 by boxes in dashed lines. The or each apparatus-mounting area 40 preferably includes a support body aperture 42 through which liquid may pass. The liquid may be liquid being deposited on the first surface 38a of the first aerosolisation apparatus 14 received on the or a said apparatus-mounting area 40, for example if the second surface 38b faces away from the apparatus-mounting areas 40. The liquid may be aerosol droplets of liquid exiting the first aerosolisation apparatus 14 in the form of an aerosol plume, for example if the first surface 38a of the first aerosolisation apparatus 14 faces away from the apparatus-mounting area 40.

In the preferred embodiment, the aerosolisation system 10 includes at least one, and more preferably a plurality of first aerosolisation apparatuses 14. In FIG. 5, three first aerosolisation apparatuses 14 are shown but the first aerosolisation-apparatus support body 16 includes five apparatus-mounting areas 40, such that a further two first aerosolisation apparatuses 14 may be mounted to the same first aerosolisation-apparatus support body 16. Any alternative number of apparatus-mounting areas and/or first aerosolisation apparatuses may be provided, as required, including none, one, two, three, four, five, or at least six.

The first aerosolisation-apparatus support body 16 is movable but fixed may be an option. More specifically, the first aerosolisation-apparatus support body 16 is movable in at least one, and preferably a plurality of directions, which may be linear and/or non-linear. The first aerosolisation-apparatus support body 16 may be movable in or along any or any combination of the six degrees of freedom, which are: linear movement along the X-axis 12a, linear movement along the Y-axis 12b, linear movement along the Z-axis 12c, tilt, roll and pitch.

The first actuator 18, also referred to as a nebuliser actuator, in-use enables the, each or at least one said first aerosolisation apparatus 14 and/or first aerosolisation-apparatus support body 16 to be movable. Preferably, the, each or at least one said first actuator 18 includes a motor or motor element, not shown, but this is optional. There may be a plurality of first actuators 18. For example, each first actuator 18 may be configured to move the first aerosolisation-apparatus support body 16 and/or the or a said first aerosolisation apparatus 14 in one of the six degrees of freedom or a combination thereof. For example, there may be a first actuator 18 configured or adapted to move the first aerosolisation apparatus 14 and/or the support body 16 thereof linearly axially, i.e. along the X-axis. This actuator 18 may be referred to as an axial first actuator, X-axis first actuator, a translation actuator or a piezo slide actuator 18a. A further said first actuator 18 may be configured or adapted to move the first aerosolisation apparatus 14 and/or the support body 16 thereof linearly along the Y-axis 12b or an axis parallel thereto. This first actuator 18 may be referred to as a transverse actuator, Y-axis actuator or select actuator 18b. A further said first actuator 18 may be provided, configured to tilt or rotate the the first aerosolisation apparatus 14 and/or the support body 16 thereof around the Y-axis or an axis parallel thereto. This first actuator 18 may be referred to as a tilt actuator 18c. The relevance of the first aerosolisation apparatus 14 and/or first aerosolisation-apparatus support body 16 being linearly moveable and/or tiltable will become apparent hereinafter when describing the system 10 in-use.

The second aerosolisation apparatus 20 in-use produces a second aerosol, and more preferably a second aerosol plume. Whilst there is preferably only one second aerosolisation apparatus 20, a plurality may easily be provided. Either or both of the first and second aerosolisation apparatuses may even be omitted from the system 10. The second aerosolisation apparatus may be similar or the same as the or a said first aerosolisation apparatus. However, in the second aerosolisation apparatus 20 preferably includes a capillary or needle. Even more preferably, the capillary is an electrospray capillary. The second aerosolisation apparatus 20 has an aerosolisation apparatus inlet 44a and an aerosolisation apparatus outlet or tip 44b. Any alternative to an electrospray capillary may be an option however, such as a nanospray needle.

The second aerosolisation-apparatus support body 22 in-use provides a support for the second aerosolisation apparatus 20. Here, the second aerosolisation-apparatus support body 22 is in the form of a housing element having a support arm but any alternative embodiment may be envisioned. The second aerosolisation-apparatus support body 22 is movable, but non-movable may be an option. Furthermore, the second aerosolisation-apparatus support body 22 may be movable in or along any or any combination of the six degrees of freedom. Preferably however, the second aerosolisation-apparatus support body 22 is only linearly movable, and more preferably only movable along the X-axis.

The second actuator 24 in-use enables the, each, or a said second aerosolisation apparatus 20 and/or the second aerosolisation-apparatus support body 22 to be movable. Preferably, the second actuator 24 includes a motor or motor element, not shown, but this is optional. The second actuator 24 is configured or adapted to move the second aerosolisation apparatus 20 and/or the support body 22 thereof to be movable, preferably axially along the X-axis 12a. The second actuator 24 may be referred to as a needle actuator, a capillary actuator, a needle translation actuator or a needle slide actuator, for clarity. One or more further second actuators may be provided, for example, to enable movement in any or any combination of the six degrees of freedom, as required.

The liquid-deposition means 26 in-use enables liquid to be added to, deposited in or on, or supplied to the, each or at least one said first and/or the, each or at least one said second aerosolisation apparatus 20. The liquid-deposition means 26 may also be referred to as a fluid drive, liquid-supply means, liquid supplying element, liquid depositing element, liquid supplier, or liquid dispenser.

The liquid-deposition means 26 preferably includes at least one feed, such as a tube, straw, or syringe, but any additional or alternative may be envisioned. For instance, a wick, wet material, optionally a wet fibrous material, may deposit or supply liquid by being at least temporarily engaged with or in contact with the relevant part the or each aerosolisation apparatus. Optionally, the liquid-deposition means may be or include a distinct device, such as liquid handling robot, a pipette, and more preferably a micropipette, a pump, and more preferably a syringe pump. The pipette may be automated or manually operated. Referring back to the embodiment shown in FIG. 1, the liquid-deposition means 26 includes five feeds, one associated with each nebuliser 14a and optionally one or more syringe pumps associated with one or more of the feeds. A syringe pump, not shown, is associated with the capillary.

Optionally, the liquid-deposition means 26 may include a liquid-measurement means or measurer to measure or indicate the volume of liquid being dispensed. The measurer may be manual and/or automated, such as by comprising a motor. An indication of the volume of liquid being dispensed may include graduations. In an alternative embodiment, the control means may instead determine and/or control the volume being dispensed. The power supply or power source 30 in-use supplies power to the aeosolisation system 10 or any part thereof. More preferably, the power supply 30 may in-use energise or provide electricity to any or any combination of: each or a said first actuator 18, each or a said second actuator 24, each or a said first aerosolisation apparatus 14, each or a said second aerosolisation apparatus 20, the control means 28 or part thereof, the liquid-deposition means 26 and any further part of the aerosolisation system 10. The power supply 30 may be the electrical mains and/or a portable power supply such as a generator or a battery. There may be a plurality of power supplies 30. For example, each or at least two aerosolisation apparatuses may be associated with a distinct power supply, although a common power supply may be an option.

Control means 28 in-use enable the control of the aerosolisation system 10, or parts thereof. The control means 28 may also be referred to a controlling element or part, or controller. The control means 28 includes a grounded portion 46a and an isolated portion 46b, but either feature may be omitted and/or a plurality of any of the above may be provided. The grounded portion 46a and the isolated portion 46b are illustrated in FIGS. 6 and 7, as boxes in dotted lines.

The grounded portion 46a includes a grounded processing element 48, one or more communication channels 50, one or more control sub-units 52, input means 54, and output means 56, although any of the above may be omitted and/or a plurality of any of the above may be provided.

The grounded processing element 48, also referred to as a master processor, in-use processes or integrates one or more inputs and/or provides one or more output. The inputs and/or outputs may be in the form of data, a signal, a command, a computer program, a graph, or any other suitable form. The grounded processing element 48 includes a grounded controller and more preferably a grounded microcontroller.

Each communication channel 50 in-use enables data transmission therealong. Transmission may be unidirectional or bi-directional. The, each or at least one communication channel 50 may be wireless or wired. The system 10 may even include a combination of wired and wireless communication channels 50. A wireless communication channel 50 may include Bluetooth (RTM), Near-Far Communication NFC, Wi-Fi, or internet, by way of examples only. A wired communication channel 50 may include a cable, or a circuit line printed on a circuit board, by way of example only.

The or each control sub-unit 52 may take any form as long as it is able to carry out a control function. Examples of suitable embodiments of a said control sub-unit 52 include a circuit or circuit portion, processor, controller, or microcontroller. The or the plurality of control sub-units 52 preferably control at least one of the above actuators 18, 24. More preferably, each of the first and/or second actuators 18, 24 is controlled by a dedicated control sub-unit 52. In the present embodiment, the plurality of control sub-units 52 preferably includes: an X-axis first actuator control sub-unit 52a, a select actuator control sub-unit 52b, a tilt actuator control sub-unit 52c, and a needle actuator control sub-unit 52d. The, each or at least one of the control sub-units 52 is communicable with the grounded processing element 48 via a said communication channel 50. Data transmission is preferably unidirectional. More preferably, the direction of data transmission is only from the grounded processing element 48 to the control sub-unit 52, but the reverse direction or bi-directional transmission may be options. Optionally, a further said control sub-unit 52 may also be provided to control the fluid drive or liquid-deposition means 26.

Although the grounded processing element and the or each control sub-unit are illustrated and described as being distinct parts or features, it may be easily envisioned that any number of control sub-units may be combined into a single control sub-unit. One or more control sub-units may even be part of the grounded processing element.

The input means 54, also referred to as an input element or input portion, in-use enables an input, such as from the user, to be provided to the grounded processing element 48. The input means 54 may be provided in any suitable form, such as any or any combination of: a button, a trigger, a microphone, a keyboard, a mouse, a computing device, an emitter, a receiver, a transducer, or any other suitable device. The computing device may be a desktop, laptop, or a personal communications device, such as a phone, and more preferably a smartphone. In the preferred embodiment, the input means 54 includes a trigger 54a and a computing device 54b. The computing device 54b may be unidirectional or bidirectional such that the computing device 54b may be both an input means 54 and an output means 56.

The output means or output element or part 56 in-use enables an output to be provided from the grounded processing element 48. Similarly to the input means 54, the output means 56 may be provided in any suitable form, such any or any combination of a computing device, an emitter, a receiver, a transducer, a speaker element, a visual-output element, or any other suitable device. The computing device may be a desktop, laptop, or a personal communications device, such as a phone, and more preferably a smartphone. Examples of visual-output elements may include a light and/or a screen, by way of example only.

If an isolated portion 46b is provided, preferably, the control means 28 further comprises an optoisolator 58. The optoisolator 58, also referred to as an optical coupler, photocoupler or optocoupler, in-use enables a signal to be transmitted between the grounded portion 46a and the isolated portion 46b. To do so, the optoisolator 58 is configured to convert an electrical signal into a light signal which can bridge or cross an isolating element or gap, before being converted back into an electrical signal again. Preferably, the optoisolator 58 includes an opto-electronic emitter 60a and an opto-electronic receiver 60b. The opto-electronic emitter 60a is preferably part of the grounded portion 46a whilst the opto-electronic receiver 60b is part of the isolated portion 46b but the opposite may be envisioned. Either or both may even be bi-directional opto-electronic transducers. The opto-electronic receiver 60b preferably includes a photodiode, by way of example. The opto-electronic emitter 60a preferably includes a light source, such as an LED. Any suitable optoisolator and/or any wavelength, including visible light, infrared, may be used.

The isolated portion 46b in-use enables electronic components that are part of the isolated portion 46b to be floated to or operated at a higher voltage, if desired, without or with a lower risk of being damaged, due to being electrically isolated. The isolated portion 46b includes an isolating barrier 62, to in-use isolate the electronic components of the isolated portion 46b. The isolating barrier 62 may be provided in any form such as an air gap and/or a part formed of a non-conductive material, and/or by providing distinct circuit boards. In the preferred embodiment, the isolated portion 46b and the grounded portion 46a are provided on the same physical circuit board but as the board is formed of non-conductive material and no conductive wire, circuit line or conductive bridge connects the isolated portion 46b to the grounded portion 46a, the isolated portion 46b is electrically isolated from the grounded portion 46a. If there is no requirement for some of the components to operate at a higher voltage, the isolated portion can be operated as if it were grounded or may be omitted.

The isolated portion 46b is set up, configured or adapted to control the or a further power supply 30 to output an AC to the first aerosolisation apparatus 14. The isolated portion 46b may thus be referred to as an AC control circuit 46b. The isolated portion 46b preferably comprises an isolated processing element 64, a DC-DC converter 65a, DC-to-AC converter 65b, and an aerosolisation apparatus drive 66, but any of these features may be omitted and/or a plurality of any of the above may be provided.

The isolated processing element 64 is preferably a controller and more preferably a microcontroller. The isolated processing element 64 may be programmable. The isolated processing element 64 may be configured or adapted to control the or a said aerosolisation apparatus drive 66.

The DC-DC converter in-use converts a low voltage from the or a power source 30, which may optionally be part of the grounded portion 46a, to a higher DC voltage. The low voltage may be 5 Volts, whilst the higher voltage may be 48V by way of examples only. The DC-to-AC converter in-use converts the higher DC voltage into an AC voltage. The AC voltage is applied to the isolated portion 46b and preferably all components thereof, such as the drive 66.

The aerosolisation apparatus drive 66 in-use activates, controls and/or actuates anaerosolisation apparatus. Each first and/or second aerosolisation apparatus 14,20 may be controlled by the same or, preferably, a distinct aerosolisation apparatus drive 66. In the preferred embodiment, the second aerosolization apparatus 20 is preferably controlled by a further control means, or at least a further drive 66 and/or further power supply 30 of, separately of the control means 28. Furthermore, the liquid deposition means 26 associated with the second aerosolization apparatus 20 is preferably controlled by the further control means or controller or a third control means altogether. However, the second aerosolization apparatus and/or liquid deposition means for any of the aerosolization apparatuses may easily be controlled by the same control means as the first aerosolization apparatus.

If any of the aerosolisation apparatuses is not required to be operated at a high voltage, the corresponding aerosolisation drive may not necessarily be part of the isolated portion and may optionally be part of the grounded portion.

Although shown as distinct features, it is understood that any said drive or any part thereof in the isolation portion and/or the grounded portion may be part of the or the relevant processing element.

The aerosolisation system 10 further includes an offset voltage controller 68. As previously mentioned, there may be a plurality of power supplies 30. One of the plurality of power supplies 30 may be an offset power supply 30a. The offset power supply 30a and/or the offset voltage controller 68 may be integrated into the grounded portion 46a and/or the isolated portion 46b. Alternatively, as is the case here, the offset power supply 30a and the offset voltage controller 68 are preferably distinct from the grounded portion 46a and/or the isolated portion 46b. The offset power supply 30a may be a generator, battery or electrical mains. The offset voltage controller 68 may be part of and/or may be communicable via one or more communication channels 50 with any or any combination of: the grounded processing element 48, the isolated processing element 64, any of the control sub-units 52, the input means 54, the output means 56, and the offset power supply 30a. The offset voltage controller 68 can be configured to in-use control said the offset power supply 30a to output a voltage to the isolated portion 46b or any part thereof. This enables the isolated portion 46b to operate at a higher voltage. In turn, the AC outputted to the second and/or first aerosolisation apparatus is offset by the offset voltage. The effect of the offset voltage is that the aerosol plume is net charged. Thus, the offset voltage in-use controls the production of charged droplets of liquid.

It is understood that no offset voltage may be applied. In such case, the offset voltage controller 68 has the ability to and may even be set up or configured to output an offset voltage but no offset voltage may be outputted. No offset voltage being outputted may be due to the offset voltage controller 68 being in an inactive condition. The offset voltage controller 68 may alternatively have received a command not to output a voltage. In a further alternative, the offset voltage controller 68 may in-use output an offset voltage, the value of which may be zero.

Preferably, the offset voltage controller 68 is a DC offset voltage controller 68. A DC offset voltage controller 68 is configured or adapted to control the power supply 30 to output a DC offset voltage. The alternating current is biased by a voltage of fixed or constant value. The value may be positive or negative. The modulus or absolute value of the offset voltage may be at least 1 Volt (V), although less than 1V may be envisioned. More preferably, the absolute value is at least 10V, and more preferably at least 20V. Any absolute value of the offset voltage therebetween may be envisioned, such as 1, 2, 3, 4, 5, 6, 7, 8, 9, 10, 11, 12, 13, 14, 15, 16, 17, 18, or 19V. More preferably, the absolute value of the offset voltage is, in increasing order of preference, at least: 20, 30, 40, 50, 100, 200, 300, 400, 500, 600, 700, 800, 900, 1000, 2000, 3000, 4000, 5000, 6000, 7000, 8000, 9000, and 10000 Volts, by way of example only. Any absolute value of the offset voltage greater than 600V may be considered “high voltage”.

Alternatively, the value of the offset voltage may be varying or variable over time. For example, the offset voltage may increase or decrease over time, optionally monotonically. The offset voltage may follow a predictable pattern over time, such as a sine wave, square wave, or saw-tooth pattern, by way of examples only. More preferably, the or a further said offset voltage controller 68 may be an AC offset voltage controller 68. An AC offset voltage controller 68 may be configured to control the or a said power supply 30 to output an AC offset voltage to the said isolated portion 46b. The value of the offset voltage may be zero, positive, negative, or alternate between two or all three. The absolute value of any of: the minimum, median, average, or maximum AC offset voltage may have any of the absolute values described in relation to the DC offset voltage. The absolute values provided above may even be a lower and/or upper bound.

An aerosolisation assembly 70 may be provided which includes at least the above-described aerosolisation system 10, and optionally a device that uses and/or analyses gas phase ions 72.

The device that uses and/or analyses gas phase ions 72 may be referred to as an analysis device, for conciseness. The aerosolisation system 10 may optionally be retrofitted to an existing analysis device 72. A device that uses gas phase ions may require gas phase ions in order to function. A device that analyses gas phase ions may be functional without gas phase ions but may be used to carry out an analysis of gas phase ions. An example of an analysis device 72 may be a mass spectrometer 74. The analysis device 72 has an inlet aperture 73 in the preferred embodiment but it may easily be envisioned that the analysis device may have no inlet aperture. For example, the aerosolisation system may be an internal component of the analysis device. The inlet aperture 73 in-use enables at least part of the aerosol plume therethrough. Preferably, the analysis device 72 is a mass spectrometer but any alternative analysis device may be used, such as tandem mass spectrometers, ion mobility spectrometers, or field asymmetric ion mobility spectrometers, secondary ion mass spectrometry, thermal ionisation mass spectrometry, ambient ionisation mass spectrometry, and gas chromatography.

In use, the aerosolisation system 10 may be provided as a kit of parts, the kit comprising at least one first aerosolisation apparatus 14 and/or at least one second aerosolisation apparatus 20. The user may need to assemble the aerosolisation assembly 70 or the system 10 thereof, if provided in a disassembled condition or in a part-assembled condition. Any of the components of the aerosolisation assembly 70, such as the or each first aerosolisation apparatus 14 and/or the or each second aerosolisation apparatus 20 may be obtained by a user, with or without any further parts of the system 10, for example, as consumables. Preferably however, the or each first aerosolisation apparatus 14 and/or the or each second aerosolisation apparatus 20 is provided with their respective support body 16, 22. More preferably, the kit contains all the required components of the assembly 70.

To assemble the aerosolisation system 10, the user carries out some or all of the following steps, not necessarily in the following order.

The, each, or the plurality of aerosolisation apparatuses is engaged with their respective aerosolisation-apparatus support bodies. The user may install up to five nebulisers 14a on the first aerosolisation-apparatus support body 16 in the present embodiment, but the system 10 may even be configured to accept more than five nebulisers. The user may not necessarily use all the installed nebulisers 14a. The or each aerosolisation-apparatus support body is engaged with the relevant actuator or actuators. A plurality of nebulisers provides the ability to easily and rapidly provide a plurality of aerosol plumes originating from a plurality of liquids, at least more quickly and easily than having to empty, clean and refill a capillary between aerosolising two liquids. Distinct nebulisers may also help to avoid contamination of liquids.

The control means 28 is configured to be communicable with any or any combination of: the, each or at least one power supply 30; the, each or at least one said actuator 18, 24; the, each or at least one said aerosolisation apparatus 14, 20; the, each or at least one support body; and the liquid-deposition means 26, if provided.

The control means 28 is also configured to control the or each first aerosolisation apparatus 14 and/or the or each second aerosolisation apparatus 20. More preferably, the control means 28 is configured to control the, each or at least one power supply 30, which is preferably the isolated power supply 30, to provide an electrical current, preferably an AC, to the or each first aerosolisation apparatus 14 and/or the or each second aerosolisation apparatus 20.

Optionally, the offset voltage controller 68 may be configured to control the offset power supply 30 to provide an offset voltage to at least one of: the first aerosolisation apparatus 14, the second aerosolisation apparatus 20, and the AC control circuit 46b.

Once the aerosolisation system 10 is in an assembled condition and has at least a first aerosolisation apparatus 14, a, notionally first, volume of, notionally first, liquid 76 is added to the first aerosolisation apparatus 14. As the first aerosolisation apparatus 14 is preferably a nebuliser 14a, the first volume of first liquid 76 is added onto the first surface 38a of the vibratable sheet 34. The AC control circuit 46b is activated to control the or a said power supply 30 to provide an AC to the first aerosolisation apparatus 14, and more preferably to the vibration means 36 thereof. The energised vibration means 36 causes the vibratable sheet 34 to vibrate.

The vibration frequency of the vibratable sheet matches or substantially match the frequency of the AC received. More preferably, the vibratable sheet 34 vibrates at an ultrasonic frequency i.e., at least 20 kilohertz, although any frequency below 20 kHz may be envisioned, such as 15 kHz, 10 kHz, 5 kHz, 3 kHz, 1 kHz, 500 Hz, 250 Hz, 100 Hz, or 50 Hz, or any value in between, by way of examples only. Even more preferably, the frequency of the AC may be any of: 50 kHz, 60 kHz, 70 KHz, 80 kHz, 100 kHz, or any value in between. Any value greater than 100 kHz may be an option.

In the preferred embodiment, as the vibration means 36 preferably includes a piezo element, upon being energised, the piezo element begins to vibrate, a phenomenon known as the piezo effect. The piezo element may be energised mechanically, thermally by a thermal pulse, by a laser or an electrical current. The piezo element may only be energised in response to a specific frequency or range of frequencies, which is preferably the range of 74.95 kHz to 75.05 KHz.

Unless the piezo element is energised further, dampening results in the piezo element ceasing to vibrate. For example, the piezo element of the vibration means 36 may vibrate at a frequency of 75,000 Hertz or 75 kHz when energised. The period is calculated as 1/frequency such that the period is 1/75,000 seconds. The vibratable sheet 34 may have an amplitude of 50V. The user may decide to deliver a burst of AC lasting at least one, and more preferably five periods to the piezo element. It is understood however that this represents only one example of a possible configuration of the settings of the aerosolisation system 10 and that different settings or parameters may be envisioned. Delivering a pulse or burst of electricity i.e. electricity delivered over a short time period, provides fine control over the vibration frequency and duration of the vibratable sheet 34. In turn, fine control over the vibration frequency provides fine control over the rate of aerosolisation and/or volume being aerosolised.

When the vibratable sheet 34 vibrates, the liquid 76 is forced through the apertures 38c via inertia. Upon reaching the second surface 38b, the restoring inertial force becomes greater than the surface tension. This imbalance results in an aerosol plume 78 of droplets 80 being formed from the first volume of first liquid 76, as the droplets 80 detach from the second surface 38b with momentum.

As previously mentioned, the aerosol plume resulting from a nebuliser is ordinarily net neutral. The user may decide not to activate the offset voltage controller, if a net neutral aerosol plume is required throughout or for part of an experiment. However, if an aerosol plume of charged droplets is required, the offset voltage controller 68 is activated. The activation may be due to an input from the user and/or from a software programme. Activation of the offset voltage controller 68 results in the AC control circuit or isolated portion 46b being raised by the offset voltage 81. FIGS. 8a and 8b illustrate the effect of the offset voltage 81, as FIG. 8a shows the AC prior to the offset voltage 81 being applied and FIG. 8b showing the AC to which the offset voltage 81 is applied. The AC voltage is positively or negatively biased in the case of a positive or negative offset, respectively. As the vibratable sheet 34 is preferably conductive, the voltage offset may electrify the vibratable sheet 34 and thereby result in droplets 80 of liquid 76 becoming charged by gaining or losing one or more electrons upon exiting the nebuliser 14a. As such, an imbalance between the positively charged molecules and negatively charged molecules results in a net charged aerosol plume, whether positive or negative. A greater offset creates a greater imbalance. There may be a minimum offset voltage value at which molecules of the opposite charge, and optionally neutral droplets, may be entirely or substantially entirely eliminated from the aerosol plume.

If a further or second aerosol plume 78 is desired, a further aerosolisation apparatus 14, 20 may be provided. The further aerosolisation apparatus 14, 20 may be of a different type or the same type as the aerosolisation apparatus 14, 20 configured to which produces the first aerosol plume 78. In other words, the further aerosolisation apparatus 14, 20 may be either a said first aerosolisation apparatus 14 i.e. a nebuliser or, more preferably, a said second aerosolisation apparatus 20. In the preferred embodiment, the further aerosolisation apparatus 20 is a capillary. More preferably, the capillary is an electrospray capillary. A further or second volume of further or notionally second liquid is added to first and/or the second aerosolisation apparatus 14, 20. The second liquid may be added at any point of assembly or use, such as: during or after assembly of the aerosolisation system 10, before, simultaneously or after adding the first liquid 76 to the first aerosolisation apparatus 14. The first volume and second volume may be the same or different volumes. The first liquid and the second liquid may be the same liquid, different liquids, or one liquid may include the other liquid. Any of the liquids disclosed herein and throughout may include one or more of: a solute, a solvent, a reagent, a calibrant ion, a plurality of any of the above, and any combination thereof. If including at least one solute and at least one solvent, the liquid may be considered to be or to include a solution. Any of the liquids may alternatively be a pure chemical compound and/or chemical element. A user may want to make use of one or more aerosol plumes produced by the aerosolisation system in a specific application. The user may therefore provide or obtain an analysis device 72.

### Direct Mode

If only one aerosol plume is required, the aerosolisation system 10 only requires a minimum of one aerosolisation apparatus. Preferably, the aerosolisation apparatus 14 is a nebuliser 14a, but a capillary could be envisioned instead. If a single aerosol plume 78 is required, there may be no capillary. If additional aerosolisation apparatuses 14, 20, and more preferably one or more additional nebulisers 14a, are provided, there may be a choice from which one aerosolisation apparatus 14, 20 may be selected and/or activated. As the aerosol droplets 80 leave the second surface 38b of the or the active nebuliser 14a and move along the nebuliser output axis, the second surface 38b of the vibratable sheet 34 is oriented or re-oriented to face the inlet aperture 73 of the analysis device 72. If not already oriented and/or positioned appropriately, one or more of the actuators 18, 24 may move the aerosolisation apparatus 14, 20 and/or support body 16, 22 thereof into an in-use position and/or orientation. Manual orientation or re-orientation may also be an option. More preferably, the axial first actuator 18a and/or the select actuator 18b may move the aerosolisation apparatus 14 and/or support body 16 thereof axially and/or transversally to move the selected aerosolisation apparatus 14 into a required position. The tilt actuator 18c may rotate or tilt the aerosolisation-apparatus support body 22 and/or the or each aerosolisation apparatus 14.

The aerosol plume 78 of, optionally charged, droplets 80 is moved until the plume is directed to, toward or adjacent to the inlet aperture 73 of the analysis device 72. This configuration may be referred to as the “direct mode” and is illustrated in FIG. 9, which shows the nebuliser 14a in-use, emitting an aerosol plume 78 directed generally toward or in the vicinity of the inlet aperture 73 of the analysis device 72.

Optionally, the inlet aperture 73 may provide a suction or aspiration force on droplets 80 which are moving towards the inlet aperture 73 and/or which are in the vicinity of the inlet aperture 73. The aspiration force may be generated by virtue of a pressure gradient due to a pressure differential on either side of the inlet aperture 73. The pressure gradient may be set up by a vacuum or partial vacuum being generated within the analysis device 72, by way of example.

### Indirect Mode

The user may wish to make use of a plurality of aerosolisation apparatuses 14, 20, in combination with a said analysis device 72. The aerosolisation system 10 requires at least two aerosolisation apparatuses. The or two of the plurality of aerosolisation apparatuses 14, 20 may both be nebulisers or may both be capillaries. Preferably however, the aerosolisation system 10 includes a first aerosolisation apparatus 14, which is preferably, a nebuliser 14a; and a second aerosolisation apparatus 20 which is preferably a capillary. The first aerosol plume 78 outputted by one of the aerosolisation apparatuses is directed to or toward the outlet of the other of the aerosolisation apparatuses. More preferably, the nebuliser 14a is configured to emit an aerosol plume 78 of, optionally charged, droplets to or towards the capillary, and more preferably the outlet 44b thereof. This configuration may be referred to as the “indirect mode”and is illustrated in FIG. 10.

The second surface 38b of the vibratable sheet 34 may be oriented or re-oriented to face the second aerosolisation apparatus 20, preferably by the actuator or actuators 18, although once again, manually may be an option. The actuators may be more precise and/or programmable. Preferably, the nebuliser-originating droplets 80 move along the nebuliser output axis. The angle between the nebuliser output axis and the capillary is or is about 90°, as shown on FIG. 10. Different angles to 90° may be envisioned however, such as any angle between 1° and 89°, more preferably between 20° and 70°, and even more preferably between 30° and 60°. More preferably, the vibratable sheet 34 extends in a plane which is or is substantially parallel with the X-Y plane. Thus, the nebuliser output axis therefore forms an angle of 90° with horizontal in-use. Furthermore, the vibratable sheet 34 is preferably positioned in-use above the capillary or at least the outlet thereof. Gravity may help aerosol droplets move towards the capillary. Additionally, the risk of droplets falling onto the second surface 38b of the nebuliser 14a, such as from the capillary or another source, is reduced.

Droplets from the nebuliser-originating aerosol plume 78 mix with the, optionally charged, droplets of the capillary at or adjacent the outlet 44b of the capillary. Mixing at or adjacent the point of generation of the capillary-originating aerosol plume 78 provides multiple benefits. Mixing may be more efficient. By reducing the number of collisions of droplets moving in different directions, the resulting mixed plume 82 may be denser or may have a smaller cross-sectional area. A smaller cross-section of mixed plume 82 may result in a greater proportion of the droplets 80 reaching the inlet aperture 73 or the vicinity thereof, at least compared to mixing of aerosol plumes downstream of the outlet 44b. Less liquid may thus be wasted. Droplets 80 from the nebuliser-originating plume 78 may be provided with linear momentum by the capillary, preferably in direction of the inlet aperture 73 of the analysis device 72. Providing the droplets 80 from the nebuliser-originating plume 78 with momentum in the same direction as droplets from the capillary may beneficially result in the mixed plume 82 having a generally higher average momentum. Again, this may reduce scattering of droplets.

Whilst two capillaries could be used, the benefit of at least one of the aerosolisation apparatuses being a nebuliser 14a may be that a nebuliser 14a provides greater control over the aerosolisation rate and/or volume being aerosolised. In other words, the low flow rate of the nebuliser provides greater control. This may reduce the likelihood of droplets condensing onto the capillary outlet and dropping off. It may be easily envisioned however that the capillary may even be replaced with a second nebuliser. In this alternative, the aerosol plume originating from the first nebuliser 14a may be directed toward the second surface 38b of the second nebuliser to enable mixing thereat or in the vicinity of the second surface 38b of the second nebuliser 14a.

To carry out an analysis involving at least two liquids, the user obtains or assembles an aerosolisation system 10 having either one aerosolisation apparatus 14, 20 or at least two least two aerosolisation apparatuses 14, 20. Preferably, the analysis device 72 is a mass spectrometer 74, but any alternative device may be used, depending on the analysis required.

In the case of one aerosolisation apparatus 14, 20, the aerosolisation apparatus 14, 20 is preferably in the direct mode. The aerosolisation apparatus 14, 20 is also preferably a nebuliser 14a. The two liquids are added onto the first surface 38a. Both liquids may be added simultaneously, substantially simultaneously or sequentially by the liquid-deposition means 26. The liquid-deposition means 26 may even be operated by the user, by way of example only. Vibrating the vibratable sheet 34 enables mixing of the liquids in or on the nebuliser 14a. The vibratable sheet 34 may optionally already be vibrating when either or both liquids are added onto the first surface 38a, although non-vibrating or stationary may be an option. Any number of further liquids may be added at any time, even during use of the system 10.

In the case of at least two aerosolisation apparatuses 14, 20, the apparatuses 14, 20 preferably include a nebuliser 14a and a capillary. The two aerosolisation apparatuses 14, 20 are preferably configured to be in the indirect mode. The first liquid 76 is added onto the first surface 38a of the nebuliser 14a. Similarly, the second liquid 84 is added into the capillary, before, after or simultaneously with the first liquid 76. One or both of the nebuliser 14a and the capillary may already be on, but preferably, neither are on when the liquids are added. The nebuliser 14a and the capillary are activated, simultaneously or sequentially, in any order, as required. The timing and/or order may be pre-programmed and/or may be triggered by an input, such as an input from a user. The input may be a button, trigger or switch, or a keyboard input, by way of example only.

By way of example only, the capillary may be activated to produce an aerosol plume 78 from the second liquid 84. Upon activation of the nebuliser 14a, the first liquid 76 is aerosolised into an aerosol plume 78. The two plumes mix at or adjacent the outlet 44b of the capillary, resulting in the combined or mixed aerosol plume 82. The mixed aerosol plume 82 is directed to, toward or adjacent to the inlet aperture 73 of the analysis device 72. The analysis device 72 analyses the mixed aerosol plume 78 and provides at least one analysis output. In the case of a mass spectrometer, the or each analysis output is a spectrum. Further examples illustrating specific use cases of the aerosolisation assembly 70 are provided hereinafter.

### Analysis of a Chemical or Biochemical Reaction

A chemical or biochemical reaction can be carried out and simultaneously analysed by the aerosolisation assembly 70 having one or a plurality of aerosolisation apparatuses 14, 20. The first liquid 76 includes at least one first reagent. The second liquid 84 includes at least one second reagent. When the first and second reagents are mixed, whether in or on a nebuliser 14a or at or adjacent the outlet 44b of the capillary, the first reagent reacts with the second reagent. The device that uses and/or analyses gas phase ions 72 is thereby able to analyse in real-time or substantially real time a chemical or biochemical reaction. Greater control is also provided over the timing and/or reaction rate. The aerosolisation system 10 may be in either the direct mode, for example if the reagents are mixed on the first surface of the nebuliser, or the indirect mode, if the assembly 70 includes a nebuliser and a capillary.

Carrying out a plurality of reactions may be possible. For example, a notionally first reaction may be carried out by mixing liquids on the nebuliser 14a and the nebuliser-originating mixed plume 82 being mixed in turn with a capillary-originating plume to carry out a, notionally second, reaction. Examples of reactions carried out using this system 10 include: changing the metal adducts attached to ions in a mass spectrum, altering the pH, digesting an intact protein by a proteolytic digestion enzyme, hydrogen deuterium exchange, supercharging, and chemical digestion of proteins.

### Calibration

At least one of the first liquid 76 and the second liquid 84 may include a calibration solution or calibrant ion. This may enable calibration or recalibration of the analysis device 72. More preferably, the calibration or recalibration may be carried out during use or analysis of the analysis device 72. Examples of calibration solutions or calibrant ions include reserpine, lithium chloride, an isotopically labelled calibrate, beer, such as Heineken beer, methylphosphonic acid, NaF, KF, NaHCOO in water, Cs-Monobutyl phthalate, Taurine, Histidine, CH3COOH in water, but any suitable calibration solution or calibrant ion may be used. As there is no requirement to interact with the analysis device 72 between calibration and analysis of a sample, the risk of accidentally altering the settings and/or miscalibrating the analysis device 72 is reduced.

The calibration solution or calibrant ion may be mixed with another aerosol plume 78 of another liquid. If the analysis device 72 is a mass spectrometer, the peaks corresponding to ions from the calibration solution may be included on the same spectrum. This may be a more efficient use of resources and/or time.

Alternatively, the calibration solution may not necessarily be mixed with another aerosol plume 78. For example, it may be envisioned that a calibration solution may be added to one of the nebulisers 14a. Optionally, a, notionally third, liquid may even be added to a second of the plurality of nebulisers 14a. The calibration liquid can be aerosolised or nebulised before or after the third liquid is added and/or aerosolised. The first aerosolisation-apparatus support body 16 can be moved before, after and/or in between the two nebulisers being activated, such as manually and/or via the or a said nebuliser-actuator 18. In other words, the or each of the nebulisers 14a is moved into position, as and when required. In either case, the aerosolisation system 10 may be used in the direct mode or the indirect mode.

### First Example of Ion-identification or Ion-identity Confirmation

At least one of the first liquid 76 and the second liquid 84, or part of either, such as a solution, a solute, a solvent, a chemical compound or chemical element within either liquid, produces a known output from the analysis device 72. In the case where the analysis device 72 is a mass spectrometer, the known output is a known mass spectrum. The first aerosolisation apparatus 14, here a nebuliser 14a, produces an aerosol plume 78 from one of the first and second liquids 76, 84 during a first period of time.

The second aerosolisation apparatus 20, here a capillary, produces a second aerosol plume 78 from the other of the first and second liquids during a second period of time. Alternatively, instead of distinct aerosolisation apparatuses 14, 20, the first and second liquids 76, 84 may be added to the same aerosolisation apparatus. For example, one of the two liquids may be present on the first surface 38a of a nebuliser 14a for a first period of time. The other of the two liquids may be present on the same first surface 38a for a second period of time.

In either case, the first and second periods of time are partially overlapping. This provides at least one duration or time period where ions from only one of the liquids are present during analysis and at least one duration or time period where ions from both liquids are present during analysis. In turn, the output of the analysis device 72 when ions of only one liquid are present during analysis can be compared with the output of the analysis device 72 when ions from both liquids are present during the analysis. This method may be referred to as “overspraying”.

In the case of a mass spectrometer, two mass spectra are produced: a first spectrum corresponding to ions generated from only one of: the first liquid and the second liquid, shown in FIG. 11a, and a second spectrum corresponding to ions of both the first and second liquids, in FIG. 11b.

Upon comparison of the spectra by the user and/or the control means, such as a processing element or computing device thereof, unless the liquids are identical to each other, the relative abundance of any ion or ions common to both liquids may change between spectra. This is illustrated by a change in the height of the peak or peaks, when comparing FIGS. 11a and 11b. The identity of the or each ion, the height of the peak of which varies between spectra, can be obtained or confirmed. The dotted portion of a peak represents the relative abundance of the ion resulting from the liquid or part thereof having a known mass spectrum. This enables identification or confirmation of at least part of the composition of the liquid or part thereof common to both spectra. The relative abundance of the identified ion or ions in the liquid being analysed can also be deduced from the spectrum of ions from only one liquid.

Optionally, the location of peaks may differ between spectra, if the liquid or part thereof having the known output generates at least one additional type of ion having a different charge to mass ratio compared to the ion or ions generated from the liquid being analysed. For example, in FIG. 11b, the left-most peak, shows as a dotted line, corresponds to an ion only found in the liquid or part thereof having a known output.

It could even be envisioned that the second liquid producing a known output from the device may be a calibration solution or calibrant ion.

### Second Example of Ion-identification or Ion-identity Confirmation

The second example of overspraying, i.e. identifying or confirming the identity of at least one ion via aerosolising a liquid or part thereof having a known output, is similar to the first example above. As above, at least one of the first liquid 76 and second liquid 84 or part of either liquid has a known output, more preferably a mass spectrum.

Unlike the first example, ions from both liquids are preferably present throughout but the volume and/or rate of aerosolisation of at least one of the liquids is variable or varied over time.

The rate of aerosolisation of an aerosolisation apparatus is defined as the volume of liquid being transformed into an aerosol form over a given period of time. The rate of aerosolisation can be varied by altering the power output to the aerosolisation apparatus 14, 20.

The term “power output” used herein and throughout is intended to include any or any of: the frequency applied to the aerosolisation apparatus, the amplitude of vibrations of the vibratable sheet 34 in the case of a nebuliser 14a, the timing and/or duration of a pulse of electricity to the aerosolisation apparatus 14, 20. More preferably, at least one of: the AC control circuit 46b, and the offset voltage controller 68 alters the rate of aerosolisation of the first liquid 76 by altering the power output to the vibration means 36.

The user is able to generate a plurality of spectra, in which the rate of aerosolisation of the liquid or part thereof having a known mass spectrum, is varied between spectra, as visible when comparing FIGS. 12a and 12b. The dotted portion of a peak represents the relative abundance of the ion resulting from the liquid or part thereof having a known mass spectrum. In other words, a first spectrum may represent the results of a mass spectrometer 74 analysing a mixed aerosol plume containing both first and second liquids whereby the said liquid having a known mass spectrum has been aerosolised at a first rate of aerosolisation.

A second spectrum may represent the results of a mass spectrometer 74 analysing a mixed aerosol plume 78 containing both first and second liquids whereby the liquid having a known mass spectrum has been aerosolised at a second rate of aerosolisation. The second rate of aerosolisation is preferably different to the first rate of aerosolisation. Different volumes and/or rates of aerosolisation result in the liquid or part thereof having a known mass spectrum representing a different proportion of the mixed aerosol plume 78.

In both cases, the rate of aerosolisation of the other of the two liquids preferably remains the same throughout, i.e. the rate is or is substantially constant. However, it could be envisioned that the rate of aerosolisation of the other of the two liquids may be varied, for example in a predictable pattern. Note that if either of the first rate and the second rate is null, this may correspond or substantially correspond to the first example, as there is a duration of time where only one of the first liquid and the second liquid is present.

The spectra can then be compared. Comparison may be by a user and/or the control means, such as a processing element or computer thereof. Whilst the location of all peaks indicating the charge to mass ratio of the one or more ions remains the same between spectra, the relative abundance of one or more ions may change between spectra. The varying relative abundance enables identification or confirmation of at least part of the composition of the liquid which is being analysed. In any of the above examples, if any incorrect settings are detected upon comparison of the spectra, the settings can be corrected. The correction may be automatic or automated, such as by the control means, optionally whilst the experiment is being carried out. Thus, settings can be optimised on-the-fly.

Any of the steps, features and caveats that apply to any one of the embodiments, methods or use cases may easily be provided or applicable to any of the other embodiments, methods or use cases.

Whilst one aerosolisation apparatus is directed towards another aerosolisation apparatus in the indirect mode, in an alternative configuration, the aerosol plumes outputted by each of the apparatuses may be both directed to, toward or adjacent to the inlet aperture, such that they may mix: at, adjacent to or even downstream of the inlet aperture. Alternatively, a first said aerosol plume may be directed to, toward or adjacent to the inlet aperture whilst a second said aerosol plume may be directed to intercept and mix with the first said aerosol plume. This may beneficially enable mixing of aerosols droplets. A downside of these configurations however may be that if both aerosol plumes are net charged, they may interfere with each other. For instance, charged droplets of two aerosols may repel each other if of the same polarity, which may reduce mixing. If opposing polarity, the droplets may attract, and fuse. If the droplets become too large, they may no longer be suspended.

If no high voltage offset is applied, no isolation portion may be required. In such an embodiment, the control means may only need an input means, an output means, and a processing element, although any of the above may be omitted and/or a plurality of any of the above may be provided. Any additional features may be provided.

Whilst a preferred shape may have been specified for any of the above-described features, any alternative shape may be envisioned in any of transverse or lateral cross-section, longitudinal cross-section, in side view, or in plan view. The shape may be any or any combination of: curved, part curved, non-curved, linear, part linear, non-linear, a broken line, any polygon, whether regular or irregular, having one or more chamfered and/or rounded corners, a triangle, a quadrilateral, such as a square, a rectangle, a trapezium, a trapezoid, a pentagon, a hexagon, a heptagon, an octagon, or any other polygon, a cross, an ellipse, a circle, part circular, an oval, or any abstract shape.

The or each aperture is preferably cylindrical but non-cylindrical may be an option, such as tapering in at least one dimension from the first surface 38a to the second surface 38b. For instance, the aperture may be in cross-section conical, frusto-conical, pyramidal, frusto-pyramidal, or trumpet-shaped by way of example. The aperture may form an acoustic horn.

It is therefore possible to provide an aerosolisation system which can generate at least one aerosol plume, and the, each or any of the aerosol plumes can be reliably controlled to be one of: net neutral, net positively charged, or net negatively charged, as required. The use of a nebuliser provides greater control over the volume of liquid being aerosolised and the timing of aerosolisation, as well as reducing wastage of liquid being aerosolised, compared to current apparatuses to aerosolise liquids.

It is also possible to provide a method of using an aerosolisation assembly to generate at least one aerosol plume, which may be reliably controlled to be one of: net neutral, net positively charged, or net negatively charged, as required. Where the assembly further includes an analysis device and optionally a further aerosolisation apparatus, the assembly may be employed in a range of use cases, including identification and/or confirmation of the identity of an ion, monitoring in real time or substantially real time a chemical or biochemical reaction, and calibration. Further uses may be envisioned.

It is further possible to provide an aerosolisation system which has a reduced number of apertures. A reduced number of apertures provides finer control over the rate of aerosolisation of a given volume of liquid. As residual liquid may potentially remain within an aperture after aerosolisation, reducing the number of apertures reduces the total volume of residual liquid. Consequently, the minimum volume of liquid required to produce an aerosol plume may also be reduced overall.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof. It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. The embodiments described above are provided by way of examples only, and various other modifications will be apparent to persons skilled in the field without departing from the scope of the invention as defined herein.

1. An aerosolisation system, the aerosolisation system comprising: a nebuliser including a vibratable sheet having a first surface, a second surface opposite the first surface, and an aperture extending from the first surface to the second surface; an electrically-energisable vibrator; an AC control circuit having a programmable controller, the AC control circuit being configured to control a power supply to output an alternating current to the nebuliser; and an offset voltage controller being configured to control a power supply to output an offset voltage to the alternating current control circuit so that in-use the said alternating current outputted to the nebuliser is offset by an offset voltage.

2. An aerosolisation system as claimed in claim 1, wherein at least one of:
the aerosolization system further comprises a capillary;
the vibrator includes a piezo element; or
the sheet is a metal sheet.

3. (canceled)

4. (canceled)

5. An aerosolisation system as claimed in claim 1, wherein the offset voltage controller is a DC offset voltage controller configured to control a power supply to output a DC offset voltage.

6. An aerosolisation system as claimed in claim 5, wherein the DC offset voltage controller is configured to control the power supply to output a DC offset voltage having an absolute value of at least 20 Volts.

7. An aerosolisation system as claimed in claim 6, wherein the DC offset voltage controller is configured to control the power supply to output a DC offset voltage having an absolute value of at least 1000 Volts.

8. An aerosolisation system as claimed in claim 1, wherein the offset voltage controller is an AC offset voltage controller configured to control a power supply to output an AC offset voltage to the said alternating current control circuit.

9. An aerosolization system as claimed in claim 1, further comprising an actuator.

10. Method of using an aerosolization assembly, the method comprising the steps of: a] providing an aerosolization system as claimed in claim 1; b] adding a volume of first liquid onto the first surface of the vibratable sheet and producing an first aerosol plume of charged droplets by activating the AC control circuit to control a power supply to provide an alternating current to the nebuliser and optionally activating the offset voltage controller to control a power supply to provide an offset voltage to the AC control circuit to cause the vibratable sheet to vibrate for producing the first aerosol plume of charged droplets from the volume of first liquid.

11. Method as claimed in claim 10, wherein step a] further comprises providing an aerosolization apparatus for producing a second aerosol plume of droplets and further comprising a step c] after step a] of adding a volume of a second liquid to the aerosolization apparatus so as to produce the second aerosol plume of droplets; and/or wherein step a] further comprises providing a device that an or analyses gas phase ions having an inlet aperture.

12. Method as claimed in claim 11, wherein the aerosolization apparatus is a capillary.

13. (canceled)

14. Method as claimed in claim 11, further comprising a step d] after step a] of orientating the second surface of the vibratable sheet to face the aerosolization apparatus so as to direct the first aerosol plume of droplets to or towards the aerosolization apparatus; or further comprising a step e] after step a] of orientating the second surface of the vibratable sheet to face the inlet aperture of the device that uses and/or analyses gas phase ions so as to direct the first aerosol plume of droplets to, toward or adjacent to the inlet aperture.

15. (canceled)

16. Method as claimed in claim 14, wherein at least one of the first liquid and the second liquid includes a calibration solution or calibrant ion.

17. Method as claimed in claim 14, wherein the first liquid includes a first reagent and the second liquid includes a second reagent, and the first reagent reacts with the second reagent when the first and second reagents are mixed.

18. Method as claimed in claim 11, wherein the device that uses and/or analyses gas phase ions is a mass spectrometer.

19. Method as claimed in claim 18, wherein step b] is carried out during a first period of time and step c] is carried out during a second period of time, wherein the first and second periods of time are non-partially overlapping or are partially overlapping.

20. Method as claimed in claim 18, wherein at least one of: the first liquid, part of the first liquid, the second liquid, or part of the second liquid has a known mass spectrum, wherein at least one of: the AC control circuit and the offset voltage controller alters the volume and/or a rate of aerosolisation of the first liquid by altering the output to the electrically-energisable vibrator.

21. Method as claimed in claim 10, further comprising a step f] after step a] of adding a volume of further liquid to the nebuliser of the aerosolisation system so that the first liquid mixes with the further liquid.

22. An aerosolisation system comprising: a nebuliser including a vibratable sheet having a first surface, a second surface opposite the first surface, and at most 100 apertures, the apertures extending from the first surface to the second surface; and an energisable vibrator.

23. An aerosolisation system as claimed in claim 22, wherein the vibratable sheet has at most 19 apertures.

24. (canceled)

25. An aerosolisation system as claimed in claim 23, wherein the vibratable sheet has exactly one aperture.
